(19) United States
(12) Patent Application Publication
(10) Pub. No.: US 2022/0412221 A1
(43) Pub. Date: Dec. 29, 2022

(54) Multiple Scroll Entry Turbine Turbocharger

(71) Applicant: International Engine Intellectual Property Company, LLC, Lisle, IL (US)

(72) Inventor: Ryan Vojtech, Chicago, IL (US)

(73) Assignee: International Engine Intellectual Property Company, LLC, Lisle, IL (US)

(21) Appl. No.: 17/355,827

(22) Filed: Jun. 23, 2021

(51) Int. Cl. F01D 9/02; F01D 25/30; F01D 25/24; F02C 6/12; F02B 33/40; F02B 37/02

(52) U.S. Cl. CPC F01D 9/026; F01D 25/30; F01D 25/24; F02C 6/12; F02B 33/40; F02B 37/025; F05D 2220/40; F05D 2240/12

(57) ABSTRACT

A turbocharger arrangement includes a turbine housing with multiple individual cylinder exhaust delivery scrolls, each having an individual inlet to the turbine, formed therein. The turbine housing has one individual cylinder exhaust delivery scroll for each cylinder of an engine to which the turbocharger arrangement is attached. Individual runner exhaust manifolds each connect one exhaust port of one cylinder of the engine to one of the individual cylinder exhaust delivery scrolls. The individual runner exhaust manifolds may be pipes of approximately equal length and/or equal gas flow characteristics. Separating the exhaust pulses from each cylinder with individually runner exhaust manifolds and turbine scrolls allows for enthalpy in the exhaust flow to be harnessed to a greater extent, and allows the system to be tuned for optimum energy recovery from engine cylinder blowdown.

### BACKGROUND

This disclosure relates to turbochargers for vehicle engines.

### RELATED ART

Internal combustion engines operate by drawing in air, compressing it, mixing vaporized or atomized fuel with the air either during intake or by injecting fuel during compression, and using the forcible expansion of the heated combustion gas to apply force to a piston or similar mechanism. This force is then converted to rotating motion by which power is delivered to a driveline to provide motive power for a vehicle. Such internal combustion engines operate according to known combustion cycles such as the common four stroke Otto cycle and compression ignition Diesel cycle, as well as less common combustion cycles such as the Atkinson cycle. A turbocharger may be used in conjunction with an internal combustion engine to increase the thermal efficiency and power of the internal combustion engine. Turbochargers operate by passing exhaust flow from the internal combustion engine through a turbine, which converts some of the energy remaining in the exhaust gas as temperature and pressure to mechanical rotational power of a turbocharger shaft. The turbocharger shaft then drives a compressor, typically a centrifugal compressor, which increases the pressure and temperature of the intake air. Turbochargers are often used in conjunction with an intercooler, which cools the now pressurized intake air, thereby further increasing its density. By providing the internal combustion engine with intake air having increased density, the turbocharger thereby increases the thermal efficiency and power of the internal combustion engine.¹ ¹ Otto Cycle. 14 Dec. 2020. Retrieved 1 Apr. 2021. https://en.wikipedia.org/wiki/Otto_cycle

Energy provided for the turbine work is converted from the enthalpy and kinetic energy of the exhaust gas. The turbine housing directs the gas flow through the turbine as it spins. The turbine and impeller wheel size dictates the amount of air or exhaust that can flow through the system, and the relative efficiency at which they operate. Therefore, a turbocharger's performance is closely tied to its size. Large turbochargers take more heat and pressure to spin the turbine, creating lag at low speed. Small turbochargers spin more readily, but may not have limited performance under high acceleration. To efficiently combine the benefits of large and small turbochargers, it is known to use twin-turbochargers, twin-scroll turbochargers, or variable-geometry turbochargers.

Twin-turbocharger designs have two separate turbochargers operating sequentially or in parallel. In a parallel configuration, both turbochargers are fed a portion of the engine exhaust. In a sequential setup one turbocharger operates at low engine speeds and the second turbocharger begins to operate at a predetermined engine speed or load. Sequential turbochargers reduce turbocharger lag, but require an intricate set of engine air intake and exhaust pipe to function properly.

Twin-scroll or divided turbochargers have a single turbine with two exhaust gas inlets and two nozzles, one often having a smaller sharper angle for quick response, and the other often having a larger shallower angle for peak performance. With multiple cylinder engines, it is possible for exhaust valves in different cylinders to be open at the same time, thereby overlapping at the end of the power stroke in one cylinder and the end of exhaust stroke in another. In twin-scroll turbocharger designs, therefore, the exhaust manifold may physically separate exhaust gas delivery channels of sets cylinders that interfere with each other, so that he exhaust streams from the two sets of cylinders are routed to the turbine via separate channels of differing diameter.² It is further known to use the larger exhaust channel to direct one exhaust stream to the outer edge of the turbine blades, thereby causing the turbocharger to spin faster. The smaller exhaust channel may then direct the other exhaust stream to the inner surfaces of the turbine blades, thereby improving turbocharger response. Twin-scroll technology does improve low-end response while increasing top-end power. ² Turbocharger. 1 Apr. 2020. Retrieved 1 Apr. 2021. https://en.wikipedia.org/wiki/Turbocharger

Yet even with twin-scroll turbocharger designs, multiple engine cylinders share each exhaust gas delivery channel. Because the exhaust gas flow is only separated into banks or halves of the engine, exhaust gas flow pulses still merge and interfere with each other to some extent. As a result, efficiency is lost in converting enthalpy and kinetic energy into mechanical rotational energy of the turbocharger shaft. Specifically, during the period of the combustion cycle beginning when the cylinder exhaust valve opens and extending for example to bottom dead center of the cylinder stroke, exhaust blowdown occurs. During exhaust blowdown, exhaust gasses exit the cylinder into the exhaust manifold or manifolds under high pressure, whereas during the exhaust stroke of the cylinder, exhaust pressure drops off significantly. Because multiple engine cylinders share each exhaust gas delivery channel, enthalpy and kinetic energy available for conversion to mechanical rotational energy by the turbine is lost during mixing of exhaust gas pulses from multiple cylinders.

Accordingly, there is an unmet need for an arrangement and method for improving the efficiency in converting enthalpy and kinetic energy available in engine cylinder exhaust streams to mechanical rotational energy of turbocharger shafts for the purpose of increasing engine efficiency and power.

### SUMMARY

According to one embodiment of Multiple Scroll Entry Turbine Turbocharger, a turbocharger arrangement includes a turbine connected to a compressor by a shaft. A turbine housing has multiple individual cylinder exhaust delivery scrolls formed therein. The turbine housing has one individual cylinder exhaust delivery scroll for each cylinder of an engine to which the Multiple Scroll Entry Turbocharger arrangement is attached. Individual runner exhaust manifolds each connect one exhaust port of one cylinder of the engine to one of the individual cylinder exhaust delivery scrolls.

According to another embodiment of the Multiple Scroll Entry Turbine Turbocharger, an engine has a turbocharger arrangement. The turbocharger arrangement includes a turbine connected to a compressor by a shaft. A turbine housing has multiple individual cylinder exhaust delivery scrolls formed therein. The turbine housing has one individual cylinder exhaust delivery scroll for each cylinder of the engine. Individual runner exhaust manifolds each connect one exhaust port of one cylinder of the engine to one of the individual cylinder exhaust delivery scrolls.

According to yet another embodiment of the Multiple Scroll Entry Turbine Turbocharger, a method includes several steps. The first step is connecting a turbine to a compressor using a shaft. The second step is arranging the turbine in a turbine housing with multiple individual cylinder exhaust delivery scrolls formed therein. The turbine housing has one individual cylinder exhaust delivery scroll for each cylinder of the engine. The third step is connecting each individual cylinder exhaust delivery scroll to one exhaust port of one cylinder of the engine by way of individual runner exhaust manifolds. The fourth step is providing each individual cylinder exhaust delivery scroll with an individual exhaust gas turbine inlet into the turbocharger.

### DESCRIPTION OF THE DRAWINGS

FIG. 1 is a schematic representation of a known twin-scroll turbocharger, as described herein;

FIG. 2 is a right hand side view of an embodiment of the Multiple Scroll Entry Turbine Turbocharger, as described herein,

FIG. 3 is a left hand rear perspective view of an embodiment of the Multiple Scroll Entry Turbine Turbocharger, as described herein;

FIG. 4 is a right hand rear perspective view of an embodiment of the Multiple Scroll Entry Turbine Turbocharger, as described herein;

FIG. 5 is a graph of exhaust pressure versus crankshaft angle of a known turbocharger, as described herein;

FIG. 6 is a graph of turbine blade to gas speed ratio and relative enthalpy versus crankshaft angle of an embodiment of the Multiple Scroll Entry Turbine Turbocharger, as described herein; and

FIG. 7 is a graph of turbine efficiency versus turbine blade to gas speed ratio of an embodiment of the Multiple Scroll Entry Turbine Turbocharger, as described herein.

### DETAILED DESCRIPTION

Embodiments described herein relate to a Multiple Scroll Entry Turbine, which may be embodied as both a method and an arrangement. The method and arrangement may be applied to engines of various types of passenger vehicles, commercial vehicles, and recreational vehicles, such as cars, trucks, SUVs, highway or semi-tractors, straight trucks, busses, fire trucks, motorhomes, rail travelling vehicles, and etcetera. The method and arrangement may further be applied to stationary and marine engines. It is contemplated that the method and arrangement may be applied to vehicles having drivetrains including a diesel, gasoline, or gaseous fuel engine, as well as to vehicles having hybrid electric drivetrains.

The Multiple Scroll Entry Turbine Turbocharger maintains separation between exhaust pulses originating from each individual exhaust port of an engine by way of individual runner exhaust manifolds. The individual runner exhaust manifolds lead to individual cylinder exhaust delivery scrolls formed in the turbine housing, which have individual exhaust gas turbine inlets into the turbocharger. In this way, the Multiple Scroll Entry Turbine keeps exhaust flow from each engine cylinder separate until it actually impinges onto the turbine wheel or wheels of the turbocharger. This minimizes interference between exhaust pulses from each engine cylinder. The individual runner exhaust manifolds may be pipes of approximately equal length, or more specifically of approximately equal gas flow characteristics being defined in terms of pressure drop and tuning (i.e. —exhaust scavenging, resonance, and backpressure) characteristics, leading from the individual engine exhaust ports to the individual cylinder exhaust delivery channels. Approximately in this context is defined as being within ordinary manufacturing tolerances, and/or being within variance of statistical insignificance. The individual runner exhaust manifolds and the individual cylinder exhaust delivery scrolls replace the exhaust manifold and turbocharger turbine housing, respectively, that are ordinarily used in known turbocharger arrangements.

Because the exhaust flow from each engine cylinder is kept separate until it actually impinges onto the turbine wheel or wheels of the turbocharger, an increased amount of energy is transferred from the exhaust flow pulses to the turbine wheel or wheels of the turbocharger. Specifically, as noted previously, during exhaust blowdown, exhaust gasses exit the cylinder into the exhaust manifold or manifolds under high pressure, whereas during the exhaust stroke of the cylinder, exhaust pressure drops off significantly. The pulse of exhaust that occurs during exhaust blowdown has significantly more enthalpy and kinetic energy than the rest of the exhaust portion of the cycle. As radial turbines are generally most efficient at a turbine blade to gas speed ratio (U/C₀) of 0.7, efficiency using the Multiple Scroll Entry Turbine Turbocharger is preserved, whereas typical turbine matching loses significant efficiency during blowdown due to shifts in operation points.

Further, the individual runner exhaust manifolds and individual cylinder exhaust delivery scrolls of the Multiple Scroll Entry Turbine Turbocharger allows the engine to be designed using optimal exhaust scavenging techniques, thereby further improving turbine efficiency and increasing engine power. The individual cylinder exhaust delivery scrolls and the individual exhaust gas turbine inlets may be embodied as a single construct, made for non-limiting example by casting or three-dimensional metal printing. The individual runner exhaust manifolds may be provided with individual taps or ports, in order to allow for EGRV or EGR piping.

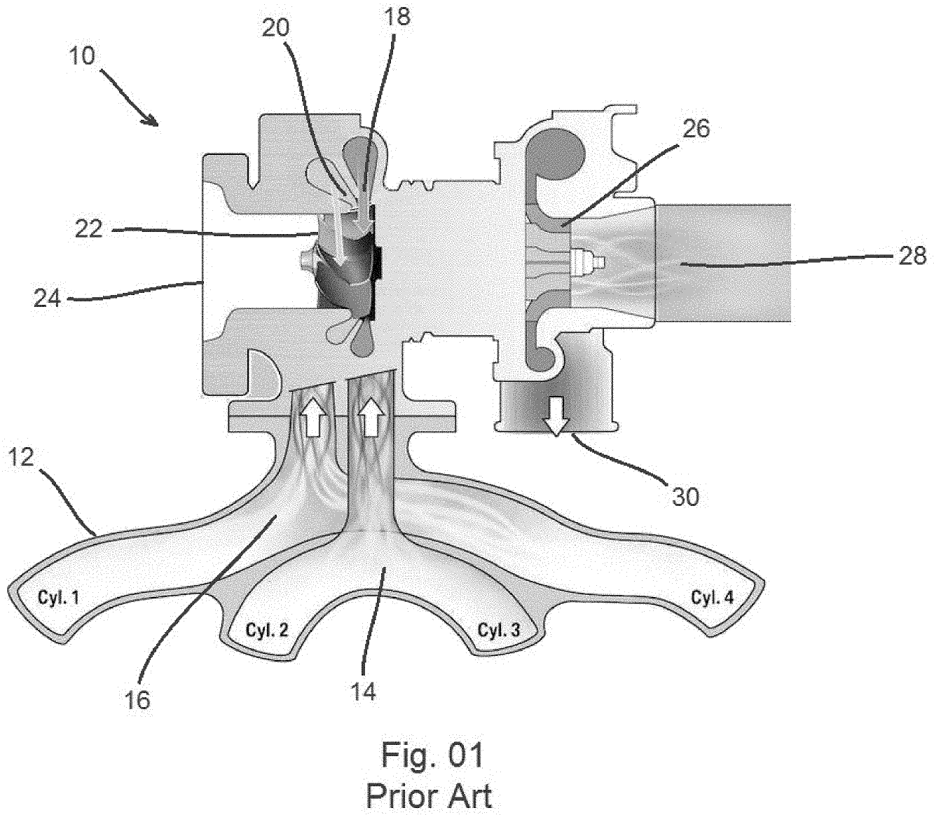

Turning now to FIG. 1, a known twin-scroll turbocharger 10 is shown. An exhaust gas manifold 12 connected to the twin-scroll turbocharger 10 is provided with a first exhaust delivery channel 14 and a second exhaust delivery channel 16. The first exhaust delivery channel 14 leads to a first exhaust gas turbine inlet 18 adjoining a turbine 22, and the second exhaust delivery channel 16 leads to a second exhaust gas turbine inlet 20 adjoining the turbine 22. Exhaust from a first set of cylinders, in this example cylinders two and three of a four cylinder engine, travels through the first exhaust delivery channel 14 to the first exhaust gas turbine inlet 18 adjoining the turbine 22, and impinges upon the turbine 22. The turbine 22 converts some of the energy remaining in the exhaust gas from cylinders two and three to mechanical rotational power of a turbocharger shaft, which turbocharger shaft then drives a compressor 26. The exhaust from cylinders two and three then continues out of the exhaust outlet 24.

Similarly, exhaust from a second set of cylinders, in this example cylinders one and four of a four cylinder engine, travels through the second exhaust delivery channel 16 to the second exhaust gas turbine inlet 20 adjoining the turbine 22, and impinges upon the turbine 22. The turbine 22 converts some of the energy remaining in the exhaust gas from cylinders one and four to additional mechanical rotational power of the turbocharger shaft, which turbocharger shaft drives the compressor 26. The exhaust from cylinders one and four then continues out of the exhaust outlet 24. The compressor 26 draws intake air from an intake air inlet 28, and provides pressurized intake air by way of an intake air outlet 30. Because exhaust flow pulses from cylinders two and three are combined in the first exhaust delivery channel 14, and because exhaust flow pulses are combined from cylinders one and four are combined in the second exhaust delivery channel 16, enthalpy and kinetic energy available for conversion to mechanical rotational energy by the turbine 22 is lost during mixing of exhaust gas pulses.

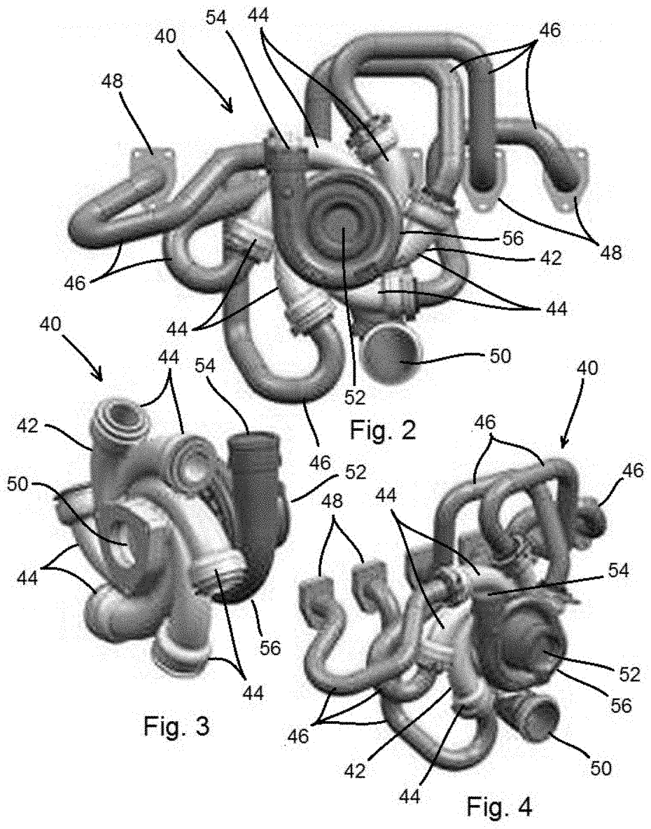

FIGS. 2, 3, and 4 show embodiments of the Multiple Scroll Entry Turbine 40 of the present disclosure. The Multiple Scroll Entry Turbine 40 is provided with a multiple scroll entry turbine housing 42 having individual cylinder exhaust delivery scrolls 44. Each individual cylinder exhaust delivery scroll 44 has an individual exhaust gas turbine inlet adjoining the single turbine (not visible). Exhaust is delivered from the individual exhaust ports 48 of a multiple cylinder engine to each individual cylinder exhaust delivery scroll 44 by way of individual runner exhaust manifolds 46. The individual runner exhaust manifolds 46 may be pipes of approximately equal length, or more specifically of approximately equal gas flow characteristics in terms of pressure drop and tuning characteristics, leading from the individual engine exhaust ports 48 to the individual cylinder exhaust delivery scrolls 44.

It is noted that the runner exhaust manifolds 46 may in some embodiments be arranged generally in an approximate plane parallel with the side of the engine, i.e. —the plane of FIG. 2. In FIGS. 2 and 4 this plane is defined by the individual engine exhaust ports 48. Further, the Multiple Scroll Entry Turbine 40 may be located so that its longitudinal axis is transverse to the longitudinal axis of the engine. After impinging upon and delivering energy to the turbine, exhaust from the individual cylinder exhaust delivery scrolls 44 then exists the multiple scroll entry turbine housing 42 by way of an exhaust outlet 50. The turbine, meanwhile, delivers the energy to a compressor 56 by way of a turbocharger shaft (not visible), which compressor 56 draws intake air from an intake air inlet 52 and provides pressurized intake air by way of an intake air outlet 54.

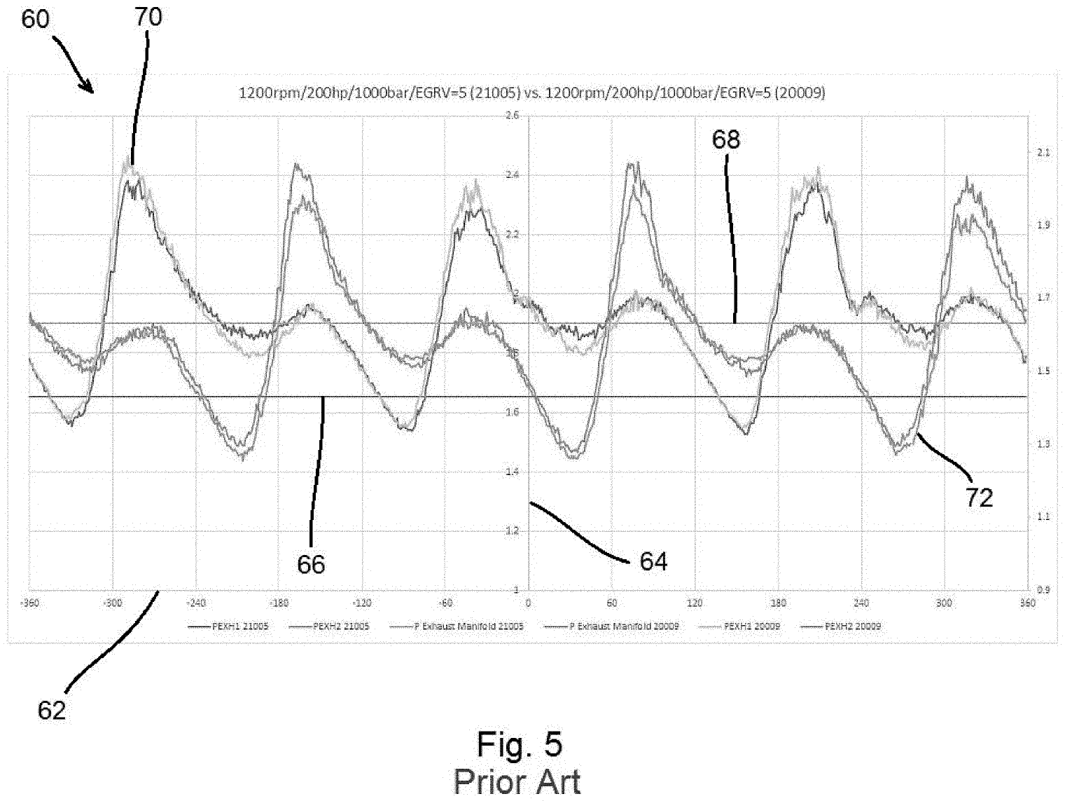

Turning now to FIG. 5, a graph 60 of exhaust pressure versus crankshaft angle is shown. The horizontal axis of the graph represents crankshaft angle 62 in degrees, and the vertical axis of the graph represents exhaust pressure 64 in bar. The graph 60 shows an example of the pressure dynamics present when exhaust pressures are measured directly using water-cooled transducers. In the case of the graph 60, the two exhaust gas measurements shown are from an engine having two banks of three cylinders exhausting into two exhaust gas delivery channels merging into a single turbine inlet scroll, as in known single inlet turbocharger arrangements. First exhaust pressure trace 66 and second exhaust pressure trace 68 represent exhaust gas pressures as they may be measured the two exhaust gas delivery channels in an engine test cell, and are heavily damped. Exhaust measurement of greater precision is shown by third exhaust pressure trace 70 and fourth exhaust pressure trace 72 showing the exhaust pressures in the two exhaust gas delivery channels.

As can be seen in FIG. 5, individual exhaust pressure waves from three of the engine's six cylinders are observed in the third exhaust pressure trace 70, and individual exhaust pressure waves from the other three of the engine's six cylinders are observed in the fourth exhaust pressure trace 72. Also observed are smaller pressure waves that result from flow and pressure waves from adjacent cylinders, as well as at the merge within the volute of the single turbine inlet scroll. As the smaller pressure waves appear in the pressure traces taken from the opposite exhaust gas delivery channels, the graph 60 of FIG. 5 demonstrates that exhaust gas flow pulses still merge and interfere with each other to some extent, even where merger of the exhaust gas flow takes place between two exhaust gas delivery channels merging into a single turbine inlet scroll.

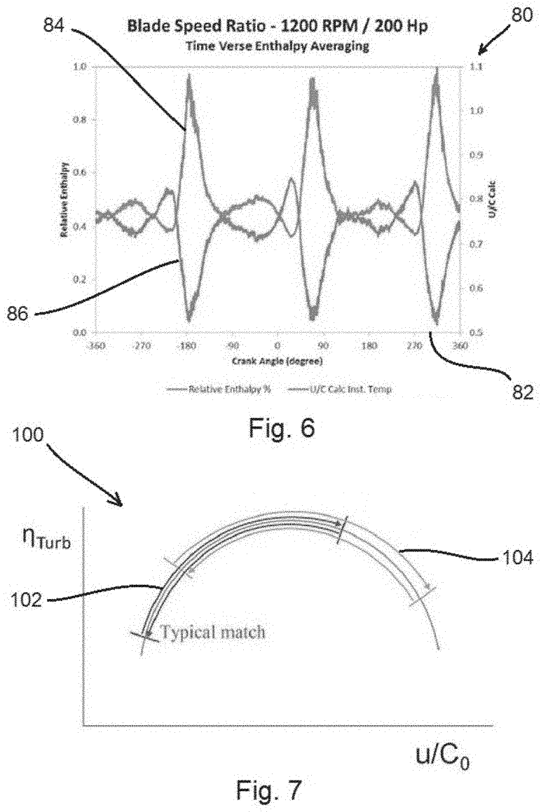

Turning now to FIG. 6, a graph 80 of turbine blade to gas speed ratio and relative enthalpy versus crankshaft angle is shown for the Multiple Scroll Entry Turbine Turbocharger of the present disclosure. Crankshaft angle 82 is measured in degrees, relative enthalpy 84 is measured in percentage, and turbine blade to gas speed 86 is given as a ratio. It is noted that the turbine blade to gas speed ratio and relative enthalpy lines are almost entirely inverse in orientation to one another. As noted previously, because the exhaust flow from each engine cylinder is kept separate until it actually impinges onto the turbine wheel or wheels of the turbocharger, an increased amount of energy is transferred from the exhaust flow pulses to the turbine wheel or wheels of the turbocharger. Less interference between exhaust flow pulses is observed, and exhaust pulse affects turbine blade to gas speed ratio 86 and pressure applied at the turbine wheel to a greater extent because of the pressure and filling dynamics in each turbine volute, thereby improving overall efficiency.

FIG. 7 shows a graph 100 of turbine efficiency versus turbine blade to gas speed ratio. A first segment 102 of the turbine efficiency versus turbine blade to gas speed ratio shows the typical range of turbine efficiency versus turbine blade to gas speed ratio. A second segment 104 of the turbine efficiency versus turbine blade to gas speed ratio shows the range of turbine efficiency versus turbine blade to gas peed ratio of the Multiple Scroll Entry Turbine Turbocharger of the present disclosure, wherein the arrangement is biased for engine cylinder exhaust blowdown. As the gas pressure wave hits the turbine wheel, the turbine wheel changes speed in response to the gas flow, thereby changing the efficiency of the airfoil of the turbine wheel. Separating the exhaust pulses from each cylinder with an individually divided exhaust manifold and turbine scroll housing allows for this pulsating behavior to be fully harnessed by way of maximal work extraction, and allows the system to be tuned for optimum energy recovery from engine cylinder blowdown.

While the Multiple Scroll Entry Turbine Housing has been described with respect to at least one embodiment, the Multiple Scroll Entry Turbine Housing can be further modified within the spirit and scope of this disclosure, as demonstrated previously. This application is therefore intended to cover any variations, uses, or adaptations of the Multiple Scroll Entry Turbine Housing using its general principles. Further, this application is intended to cover such departures from the present disclosure as come within known or customary practice in the art to which the disclosure pertains and which fall within the limits of the appended claims.

What is claimed is:

1. A Multiple Scroll Entry Turbocharger arrangement, comprising:
a turbine connected to a compressor by a shaft;
a turbine housing having multiple individual cylinder exhaust delivery scrolls formed therein, the turbine housing having one individual cylinder exhaust delivery scroll for each cylinder of an engine to which the Multiple Scroll Entry Turbocharger arrangement is attached; and
individual runner exhaust manifolds, each individual runner exhaust manifold connecting one exhaust port of one cylinder of the engine to one of the individual cylinder exhaust delivery scrolls.

2. The arrangement of claim 1, wherein:
each individual cylinder exhaust delivery scroll having an individual exhaust gas turbine inlet into the turbocharger.

3. The arrangement of claim 1, wherein:
the individual cylinder exhaust delivery scrolls being arranged in equal angular increments about a longitudinal axis of the turbine.

4. The arrangement of claim 1, wherein:
the individual runner exhaust manifolds being pipes of approximately equal length.

5. The arrangement of claim 1, wherein:
the individual runner exhaust manifolds being pipes of approximately equal gas flow characteristics.

6. The arrangement of claim 5, wherein:
the individual runner exhaust manifolds being optimized for cylinder exhaust scavenging.

7. The arrangement of claim 1, wherein:
the individual runner exhaust manifolds being arranged generally in a plane parallel with the side of the engine.

8. The arrangement of claim 1, wherein:
the Multiple Scroll Entry Turbine being located so that a longitudinal axis of the turbine is transverse to the longitudinal axis of the engine.

9. An engine having a Multiple Scroll Entry Turbocharger arrangement, the Multiple Scroll Entry Turbocharger arrangement comprising:
a turbine connected to a compressor by a shaft;
a turbine housing having multiple individual cylinder exhaust delivery scrolls formed therein, the turbine housing having one individual cylinder exhaust delivery scroll for each cylinder of the engine; and
individual runner exhaust manifolds, each individual runner exhaust manifold connecting one exhaust port of one cylinder of the engine to one of the individual cylinder exhaust delivery scrolls.

10. The engine of claim 9, wherein:
each individual cylinder exhaust delivery scroll having an individual exhaust gas turbine inlet into the turbocharger.

11. The engine of claim 9, wherein:
the individual cylinder exhaust delivery scrolls being arranged in equal angular increments about a longitudinal axis of the turbine.

12. The engine of claim 9, wherein:
the individual runner exhaust manifolds being pipes of approximately equal length.

13. The engine of claim 9, wherein:
the individual runner exhaust manifolds being pipes of approximately equal gas flow characteristics.

14. The engine of claim 13, wherein:
the individual runner exhaust manifolds being optimized for cylinder exhaust scavenging.

15. The engine of claim 9, wherein:
the individual runner exhaust manifolds being arranged generally in a plane parallel with the side of the engine.

16. The engine of claim 9, wherein:
the Multiple Scroll Entry Turbine being located so that a longitudinal axis of the turbine is transverse to the longitudinal axis of the engine.

17. An method of turbocharging an engine, comprising the steps of:
connecting a turbine to a compressor using a shaft;
arranging the turbine in a turbine housing having multiple individual cylinder exhaust delivery scrolls formed therein, the turbine housing having one individual cylinder exhaust delivery scroll for each cylinder of the engine;
connecting each individual cylinder exhaust delivery scroll to one exhaust port of one cylinder of the engine by way of individual runner exhaust manifolds; and
providing each individual cylinder exhaust delivery scroll with an individual exhaust gas turbine inlet into the turbocharger.

18. The method of claim 17, wherein:
the individual runner exhaust manifolds being at least one of:
pipes of approximately equal length,
pipes of approximately equal gas flow characteristics, and
optimized for cylinder exhaust scavenging.

19. The method of claim 17, further comprising the step of:
arranging the individual runner exhaust manifolds generally in a plane parallel with the side of the engine.

20. The method of claim 17, further comprising the step of:
locating the Multiple Scroll Entry Turbine so that a longitudinal axis of the turbine is transverse to the longitudinal axis of the engine.
